(19) United States
(12) Patent Application Publication
(10) Pub. No.: US 2005/0027938 A1
(43) Pub. Date: Feb. 3, 2005

(54) Method, apparatus and program storage device for dynamically resizing mirrored virtual disks in a RAID storage system

(75) Inventor: Todd R. Burkey, Savage, MN (US)

Correspondence Address: Crawford Maunu PLLC;Suite 390, 1270 Northland Drive, St. Paul, MN, 55120, US

(73) Assignee: XIOtech Corporation

(21) Appl. No.: 10/629,415

(22) Filed: Jul. 29, 2003

(51) Int. Cl. G06F 12/00

(52) U.S. Cl. 711/114; 711/170

(57) ABSTRACT

A method, apparatus and program storage device for dynamically resizing mirrored virtual disks in a RAID storage system is disclosed. Mirrored virtual disks are expanded by creating the amount of storage necessary by providing RAIDs on each subsystem that is associated with each of the components of the mirror set, attaching the RAIDs to the specific Virtual Disks for each of the mirror devices, and specifying the Virtual Disk size and mapping this directly to all components via the source Vdisk of the mirror set. To decrease the size of mirrored virtual disks the process is reversed, with the inclusion of the optional requirement that some raids will need to be truncated to provide exact shrink values without sacrificing storage space.

### BACKGROUND OF THE INVENTION

1. Field of the Invention

This invention relates in general to storage systems, and more particularly to a method, apparatus and program storage device for dynamically resizing mirrored virtual disks in a RAID storage system.

2. Description of Related Art

A typical data processing system generally involves one or more storage units, which are connected to a Host, or a Central Processor Unit (CPU) either directly or through a control unit and a channel. The function of the storage units is to store data and programs which the CPU uses in performing particular data processing tasks.

Various types of storage units are used in current data processing systems. A typical system may include one or more large capacity tape units and/or disk drives (magnetic, optical, or semiconductor) connected to the system through respective control units for storing data. The storage subsystem is commonly implemented as a direct access storage system (DASD) where many hard disks are organized as a redundant array of inexpensive disks (RAID).

High speed, reliable data storage and file serving is a must for any large computing system. A Redundant Array of Inexpensive Disks (RAID) is the preferred method of providing high speed, reliable data storage and file serving. From low cost arrays based on IDE disks for simple applications to multiple fibre channel Storage Area Networks (SAN) for Application Service Providers (ASP) or revenue generating e-commerce, RAID arrays are the disk storage of choice.

RAID is a family of techniques for managing multiple disks to provide desirable cost, data availability and performance characteristics to host environments. Many possible RAID configurations are available. The different types of RAID have different characteristics, advantages and disadvantages. There are two common methods for storing redundant data on disk drives: mirror and parity. In mirror redundancy, data is duplicated and stored in two or more separate areas of the storage system. In parity redundancy, redundant data is typically calculated from several areas, e.g., 2, 4, or 8 different areas, of the storage system and then stored in one area of the storage system, hence the size of the redundant storage area is less than the remaining storage area used to store the original data. Typically a raid is presented to the storage system as a LUN or a mass storage device. In a virtualized system, one or more raids will be combined into what will be referred to in this document as a Virtual Disk (VDisk). A VDisk is simply the logical concatenation of one or more Raids.

RAID systems are typically characterized as one of several architectures, enumerated under the acronym RAID. For example, a RAID 0 architecture is a striped disk array that is configured without any redundancy. Since this architecture is really not a redundant architecture, RAID 0 is often omitted from a discussion of RAID systems. A RAID 1 architecture involves storage disks configured according to mirror redundancy. Original data is stored on one set of disks and a duplicate copy of the data is kept on separate disks. The RAID 2 through RAID 5 architectures all involve parity-type redundant storage. Raid 10 is simply a combination of raid 0 (striping) and raid 1 (mirroring). This raid type allows a single array to be striped over more than two physical disks with the mirrored stripes also striped over all the physical disks.

Virtual Disk (VDisk) mirroring isn't actually a “RAID” like the other forms, but it's a critical component to RAID storage systems. The concept is to create a separate RAID (or raids) that is used to duplicate an existing RAID (or RAIDs). Mirroring allows data recovery and access via the mirrored system when a serious event takes out the entire primary system. Further, when referring to VDisk mirroring, the particular type of RAID is open in both the source and destination VDisks. Accordingly, a mirror is merely another set of one or more RAIDs of the same size as the RAID(s) being protected. So when a mirror is constructed, the mirror is the same size, but may be of a different type or configuration of RAID as the original RAID. For example, a VDisk containing two 200 GB Raid 5 arrays may be mirrored to a VDisk that contains one 400 GB raid 10 array.

As computer systems have evolved so has the availability and configuration of data storage devices, such as magnetic or optical disks. For example, these storage devices can be connected to the computer system via a bus, or they can be connected to the computer system via a wired or wireless network. In addition, the storage devices can be separate or co-located in a single cabinet.

A storage volume is a software abstraction of the underlying storage devices and is commonly the smallest self-contained unit of storage exposed by an operating system and administered by a file system. Storage volumes abstract the physical topology of the storage devices and may be a fraction of a disk, a whole disk or even multiple disks that are bound into a contiguous range of logical blocks.

Volumes are constructed from one or more extents, with each extent being a contiguous storage address spaces presented by the underlying storage device. An extent is typically characterized by the size of the address space and a starting offset for the address space from a base of the media. Volume mapping is the process of mapping the contiguous address space presented by the volume onto the usually non-contiguous storage address spaces of the underlying extents. Volume mappings are either implemented on a specialized hardware controller, referred to as a hardware volume provider, or in software by a software volume provider.

Volume mappings may be used to increase the fault tolerance, performance, or capacity characteristics of the underlying storage devices. For example, a technique for improving fault tolerance, known as mirroring or shadowing a disk, uses multiple disks. When data is written to one disk the data is also written to a second disk; thus the second disk is a “mirror image” of the first disk. If one disk should fail the other disk is still available for use and has an exact copy of the information on the first disk.

The RAID types discussed above are often used to identify storage volume mappings. A RAID, or Redundant Array of Independent Disks, provides the ability to lose an extent without losing volume data. Access to the volume may be slower or more costly, but is not interrupted by the failure of the underlying extent.

To handle ever-increasing demands for storage, to decrease the cost and burden of storage system administration, storage virtualization may be provided. The core concept of storage virtualization (of any type) is to take unmanageable complexity and make it simple. Opportunities for virtualization exist in many places throughout IT systems. For example, the “storage foundation layer” may be virtualized, i.e., the set of resources that includes the end storage devices, or spindle pool. The storage foundation layer is where data is stored and where most of your storage hardware budget is consumed over time. Foundation layer virtualization removes complexity from storage management and allows storage to be thought of as a liquid asset thereby enabling capacity, performance, and availability to be provisioned on the fly, according to the real-time requirements of your business.

The performance and capacity of all the physical disks may be combined into a central spindle pool. This pool into may be carved into logical storage volumes (virtual disks or VDisks) of any capacity up to the combined physical disk capacity in the system or the maximum size allowable by SCSI standards (whichever is less). Then, the VDisks may be assigned to servers regardless of operating system.

If a server requires greater storage, one of the server's existing VDisks may be expanded or an additional VDisk may be created and assigned to the server needing additional storage. Conversely, if a server requires less storage or is being removed from the network, this server's Vdisk may be deleted.

As drives get larger and operating systems get smarter, more aware and in control of the storage area network, dynamic resizing (both enlarging and shrinking) of virtual disk volumes becomes more desirable, but also more problematic if the VDisks are in a mirrored state. In the past, volumes could be enlarged with minimal or at least controlled impact on the operating system. However, shrinking volumes has always been problematic because most storage systems aren't virtualized, so shrinking means lots of wasted space, and any operating system is going to crash if the size of its Vdisk decreases by more than the OS is currently using. In addition, a user may want to expand and/or shrink the entire mirror set. The complexity of this problem has deterred companies from attempting this functionality. The most common approach today is simply to break mirrors prior to resizing and then re-establish the mirrors afterwards (inducing long periods of re-copying to achieve a mirrored state, during which mirror backups don't exist and inherently can put the customers data at undue risk.)

It can be seen then that there is a need for a method, apparatus and program storage device for dynamically resizing mirrored virtual disks in a RAID storage system.

### SUMMARY OF THE INVENTION

To overcome the limitations in the prior art described above, and to overcome other limitations that will become apparent upon reading and understanding the present specification, the present invention discloses a method, apparatus and program storage device for dynamically resizing mirrored virtual disks in a RAID storage system.

The present invention solves the above-described problems by manipulating RAIDs in specific logical order to provide the desired resizing of mirrored virtual disks and providing the appropriate mapping for the resizing.

A program storage device readable by a computer tangibly embodying one or more programs of instructions executable by the computer to perform a method for dynamically resizing mirrored virtual disks in a RAID storage system is provided in one embodiment. The program storage device includes a method for receiving a request to dynamically resize mirrored virtual disks in a RAID storage system, manipulating RAIDs in the RAID storage system to provide the desired resizing of the mirrored virtual disk and providing the resized mirrored virtual disks for operation.

In another embodiment of the present invention, another program storage device is provided. The program storage device embodies one or more programs of instructions executable by the computer to perform a method for dynamically expanding mirrored virtual disks in a RAID storage system, the method includes creating an amount of storage necessary by providing RAIDs on each subsystem that is associated with each component of a mirror set, attaching the RAIDs to a specific virtual disk for a mirror device and specifying a size for the virtual disk and mapping the size of the virtual disk directly to all components of the mirror set.

In another embodiment of the present invention, another program storage device is provided. The program storage device embodies one or more programs of instructions executable by the computer to perform a method for dynamically shrinking mirrored virtual disks in a RAID storage system, the method including specifying a size of a virtual disk and mapping the size of the virtual disk directly to all components of a mirror set, detaching any RAIDs that extend beyond the specified size of the virtual disk and truncating RAIDs to free up any excess physical segments back into the RAID storage system.

In another embodiment of the present invention, an apparatus for dynamically resizing mirrored virtual disks in a RAID storage system is provided. The apparatus includes a storage system interface for providing access to a storage system, host side interface for communicating with host devices and a processor, coupled to the host side interface and the storage system interface, the processor being configured for receiving a request to dynamically resize mirrored virtual disks in a RAID storage system, manipulating RAIDs in the RAID storage system to provide the desired resizing of the mirrored virtual disk and providing the resized mirrored virtual disks for operation.

In another embodiment of the present invention, a storage area network is provided. The storage area network includes a plurality of hosts, at least one access device, coupled to the plurality of hosts, for managing data input/output operations and a storage platform, for providing networked storage to at least one access device, the storage platform including a management device for dynamically resizing mirrored virtual disks in a RAID storage system, the management device further including a storage system interface for providing access to a storage system, host side interface for communicating with host devices and a processor, coupled to the host side interface and the storage system interface, the processor being configured for receiving a request to dynamically resize mirrored virtual disks in a RAID storage system, manipulating RAIDs in the RAID storage system to provide the desired resizing of the mirrored virtual disk and providing the resized mirrored virtual disks for operation.

In another embodiment of the present invention, another apparatus for dynamically resizing mirrored virtual disks in a RAID storage system is provided. This apparatus includes first means for providing an interface to a storage system, second means for providing communication with host devices and means, coupled to the host side interface and the storage system interface, for receiving a request to dynamically resize mirrored virtual disks in a RAID storage system, manipulating RAIDs in the RAID storage system to provide the desired resizing of the mirrored virtual disk and providing the resized mirrored virtual disks for operation.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a storage system according to an embodiment of the present invention;

FIG. 2 illustrates a management module according to an embodiment of the present invention;

FIG. 3 illustrates a pool of storage devices and dynamic resizing mirrored virtual disks in a RAID storage system according to an embodiment of the present invention;

FIG. 4 illustrates a flow chart of the method for dynamically resizing mirrored virtual disks in a RAID storage system according to an embodiment of the present invention;

FIG. 5 illustrates a flow chart of the method for dynamically expanding mirrored virtual disks in a RAID storage system according to an embodiment of the present invention; and

FIG. 6 illustrates a flow chart of the method for dynamically shrinking mirrored virtual disks in a RAID storage system according to an embodiment of the present invention.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the present invention.

The present invention provides a method, apparatus and program storage device for dynamically resizing mirrored virtual disks in a RAID storage system. To dynamically expand mirrored virtual disks in a RAID storage system the amount of storage necessary is created by providing RAIDs on each subsystem that is associated with each of the components of the mirror set, attaching the RAIDs to the specific Virtual Disks for each of the mirror devices, then changing the Virtual disk size of all mirror destinations and finally changing the Virtual disk size of the source. At this point, the OS(s) can scan the Virtual Disk and detect the new size and start using the full amount of space. To dynamically shrink mirrored virtual disks in a RAID storage system the operating system specifies the Virtual Disk size and maps this directly to all components via the source Vdisk of the mirror set, detaching any RAIDs that extend beyond the Vdisk range of the new size and truncating the existing RAIDs to free up any excess physical segments back into the storage pool. After this operation is done on the source VDisk of a mirror, the destination(s) will undergo the same process.

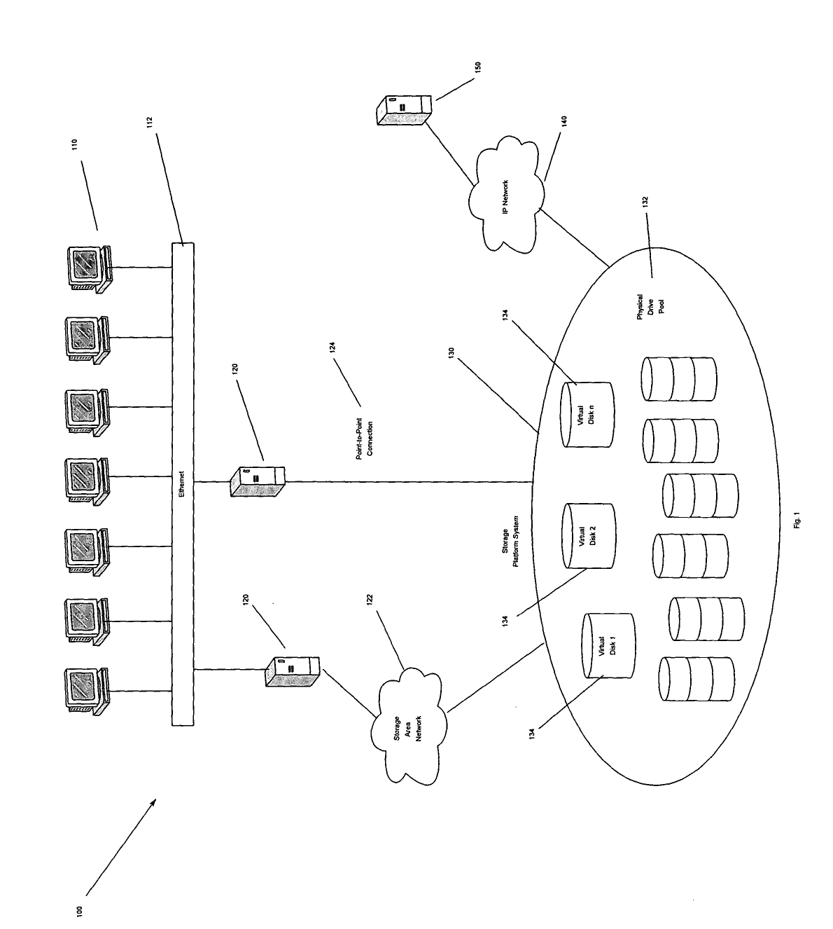

FIG. 1 illustrates a storage system 100 according to an embodiment of the present invention. In FIG. 1, multiple users 110 are coupled to a network 112. For example, Ethernet is one type of network 112. Ethernet is generally placed at the data link layer of the Open System Interconnect (OSI) 7-layer model, second from the bottom, but it also includes elements of the physical layer.

An access node 120 is coupled to a storage platform system 130. The access node 120 may be a server that is accessed by the users via Ethernet, for example, as discussed above, a gateway device, etc. The access node 120 may be coupled to the storage platform system 130 via a storage area network 122, a point-to-point connection 124, etc.

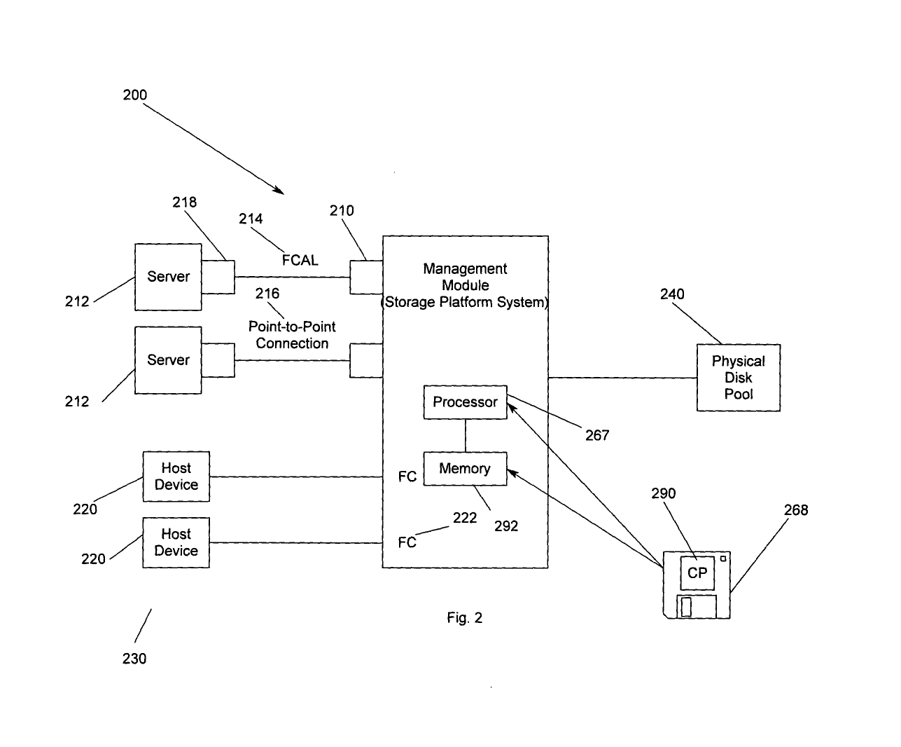

To the user 110, the storage platform system 130 appears as virtual storage device 134. The virtual storage device 134 may include a pool of storage disks 132 that are managed by a management module as shown in FIG. 2. One function of the management module is to represent information on the disks 132 to the user as at least one virtual disk 134, such as virtual disk volume.

The management module is connected to the array of disks 132 to control the allocation of data on the physical disks 132. The information on the array 132 is presented to the computer systems of the users 110 as one or more virtual disks 134 and information in the virtual disks 134 is mapped to the array 132. The storage platform system 130 may be expanded via a network connection 140, e.g., IP Network, to a remote storage platform system 150.

FIG. 2 illustrates a management module 200 according to an embodiment of the present invention. In FIG. 2, the management module 200 provides a driver via a bus interface device 210 that may be coupled to a server 212 via a connection protocol. For example, the management module 200 may be coupled to a server 212 via Fibre Channel Arbitrated Loop 214, a point-to-point connection 216, switched fabric (not shown), etc. A server 212 coupled to the management module 200 must include an interface 218 to the management module 200 via the appropriate connection protocol.

The management module 200 may be coupled directly to a host device 220. For example, the management module 200 may be coupled to a host device 200 via Fibre Channel 222. Fibre Channel 222 is a technology that allows direct connection a device to any host, server or switch. A number of ports may be provided to couple the management module 200 to hosts 230 and any combination of host types 230 may be implemented provided the appropriate interface logic is provided.

The management module 200 is also coupled to the physical disk pool 240. The pool of storage disks 240 is managed by the management module 200. The management module 200 represents information on the pool of physical disks 240 to a host 230 as at least one virtual disk, such as virtual disk volume.

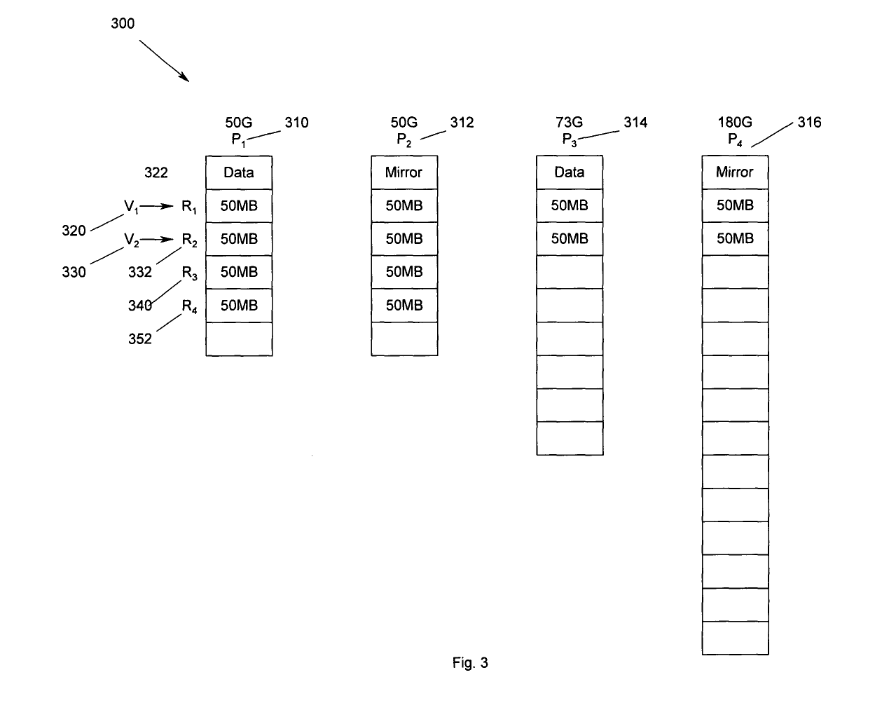

The method for dynamically resizing mirrored virtual disks in a RAID storage system, which is described in detail with reference to FIGS. 3-6 below, may be tangibly embodied in a computer-readable medium or carrier, e.g. one or more of the fixed and/or removable data storage devices 268 illustrated in FIG. 2, or other data storage or data communications devices. The computer program 290 may be loaded into the memory 292 or into the storage device 268 to configure the processor 267 of FIG. 2, for execution. The computer program 290 comprise instructions which, when read and executed by the processor 267 of FIG. 2, causes the storage device 268 to perform the steps necessary to execute the steps or elements of the present invention.

FIG. 3 illustrates a pool 300 of physical storage devices 310-316 and dynamic resizing mirrored virtual disks in a RAID storage system according to an embodiment of the present invention. In FIG. 3, only 4 physical disks are shown. However, those skilled in the art will recognize that other configurations are possible. For example, small evenly rounded RAID 10 type RAIDs may be provided. This means that twice the space may be used on the physical disks than is available in the VDisk and, in this example, where an even number of physical disks are provided, the RAID 10 mirror segments all may be shown on the same physical disks.

In FIG. 3, a first virtual disk V₁ 320 includes a first RAID partition R₁ 322 of 100 MB striped over all 4 Physical Disks (PDisks) 310-316 in the example. A second virtual disk V₂ 330 includes a second RAID partition R₂ 332 of 100 MB. Again, this may be striped over all 4 PDisks 310-316, or any number of available PDisks for that matter. V₁ 320 is mirrored to V₂ 330 and is the VDisk the attached server(s) would read/write to in normal operations. A request is made to expand V₁ 320 to 150 MB. A third RAID partition R₃ 340 of 50 MB is created and attached to the source VDisk, i.e., V₁ 320 (but the VDisk size isn't changed at this point). A fourth RAID partition R₄ 352 of 50 MB is created and attached to the destination VDisk, i.e., V₂ 330, and the reported size of all the VDisks can be changed at this point.

An extension to this is the ability to mirror from one source to multiple destinations simultaneously. In this case the process is simply expanded to expand all of the mirrors before changing the sizes of the source and destination VDisks.

The process is reversed for dynamically shrinking mirrored virtual disks in a RAID storage system, with the exception that when downsizing, you may need to shrink beyond the granularity that you expanded by. For example, in the above-mentioned 150 MB VDisk that is mirrored, to shrink this VDisk to 75 MB you would need to first reduce the size of the VDisk and its mirrors, then remove the 50 MB raid in both source and destination, and finally truncate the two 100 MB raids into 75 MB raids.

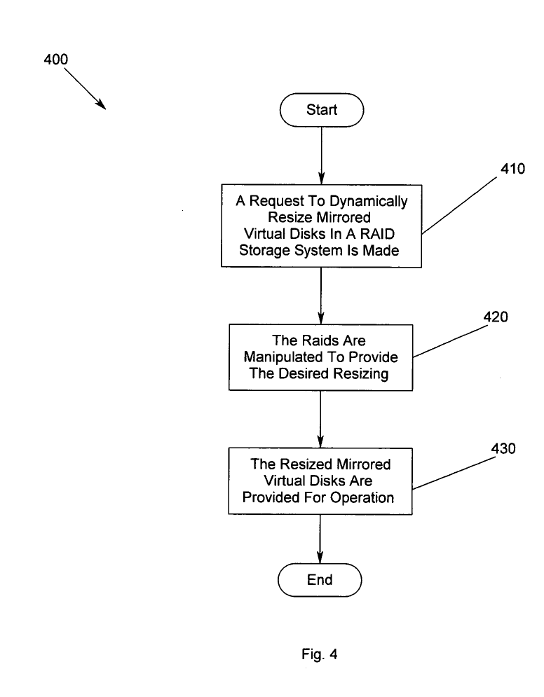

FIG. 4 illustrates a flow chart 400 of the method for dynamically resizing mirrored virtual disks in a RAID storage system according to an embodiment of the present invention. In FIG. 4, a request to dynamically resize mirrored virtual disks in a RAID storage system is made 410. The RAIDs are manipulated to provide the desired resizing 420. The resized mirrored virtual disks are provided for operation 430.

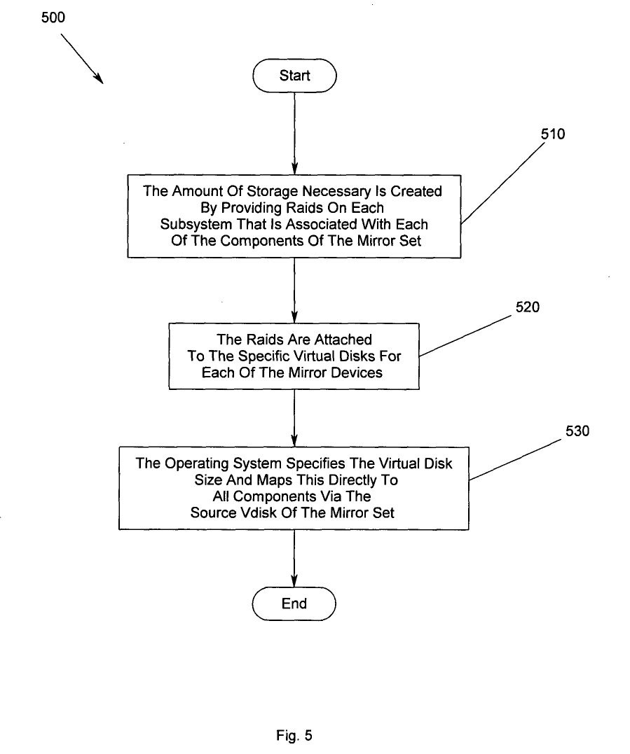

FIG. 5 illustrates a flow chart 500 of the method for dynamically expanding mirrored virtual disks in a RAID storage system according to an embodiment of the present invention. The amount of storage necessary is created by providing RAIDs on each subsystem that is associated with each of the components of the mirror set. Note that a distributed virtualized storage system may require this operation to be performed on two or more subsystems depending on the quantity and location of all the mirrors of a specific device 510. The RAIDs are attached to the specific Virtual Disks for each of the mirror devices 520. However, the Virtual disk size is changed only after all other raid create and assignment to the VDisks is compete. The operating system specifies the Virtual Disk size and maps this directly to all components via the source Vdisk of the mirror set 530. This allows the operating system to perform the specifying and mapping exactly when it knows it is permissible to do so.

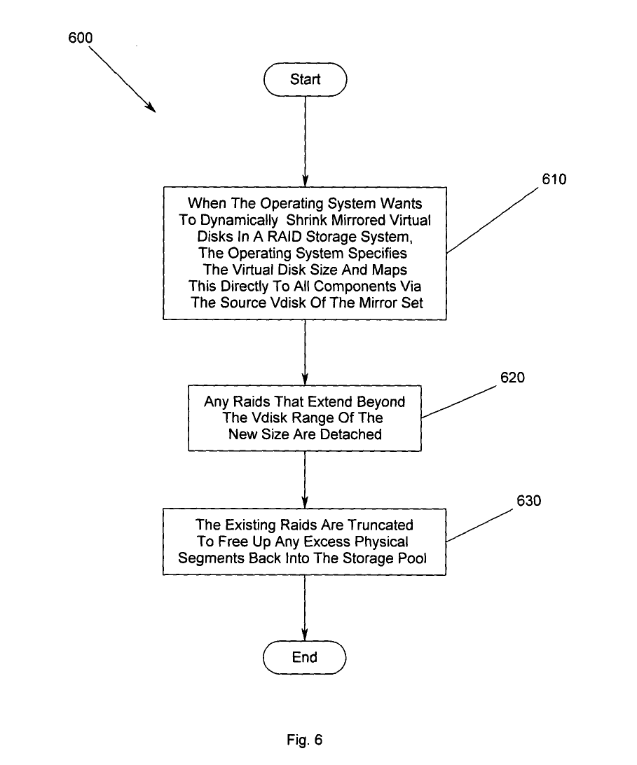

FIG. 6 illustrates a flow chart 600 of the method for dynamically shrinking mirrored virtual disks in a RAID storage system according to an embodiment of the present invention. When the operating system wants to dynamically shrink mirrored virtual disks in a RAID storage system, the operating system specifies the Virtual Disk size and maps this directly to all components via the source Vdisk of the mirror set 610. This allows the operating system OS to perform the specifying and mapping exactly when it knows it is permissible to do so. Any RAIDs that extend beyond the Vdisk range of the new size are detached 620. The existing RAIDs are truncated to free up any excess physical segments back into the storage pool 630.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

1. A program storage device readable by a computer tangibly embodying one or more programs of instructions executable by the computer to perform a method for dynamically resizing mirrored virtual disks in a RAID storage system, the method comprising:
receiving a request to dynamically resize mirrored virtual disks in a RAID storage system;
manipulating RAIDs in the RAID storage system to provide the desired resizing of the mirrored virtual disk; and
providing the resized mirrored virtual disks for operation.

2. The program storage device of claim 1 wherein the request to dynamically resize mirrored virtual disks in a RAID storage system is a request to dynamically expand mirrored virtual disks in a RAID storage system, and wherein the manipulating RAIDs to provide the desired resizing further comprises:
creating an amount of storage necessary by providing RAIDs on each subsystem that is associated with each component of a mirror set;
attaching the RAIDs to a specific virtual disk for a mirror device; and
specifying a size for the virtual disk and mapping the size of the virtual disk directly to all components of the mirror set.

3. The program storage device of claim 2 wherein the specifying a size for the virtual disk and mapping the size of the virtual disk is performed by an operating system.

4. The program storage device of claim 1 wherein the request to dynamically resize mirrored virtual disks in a RAID storage system is a request to dynamically shrink mirrored virtual disks in a RAID storage system, and wherein the manipulating the RAIDs to provide the desired resizing further comprises:
specifying a size of a virtual disk and mapping the size of the virtual disk directly to all components of a mirror set;
detaching any RAIDs that extend beyond the specified size of the virtual disk; and
truncating RAIDs to free up any excess physical segments back into the RAID storage system.

5. The program storage device of claim 4 wherein the specifying a size for the virtual disk and mapping the size of the virtual disk is performed by an operating system.

6. A program storage device readable by a computer tangibly embodying one or more programs of instructions executable by the computer to perform a method for dynamically expanding mirrored virtual disks in a RAID storage system, the method comprising:
creating an amount of storage necessary by providing RAIDs on each subsystem that is associated with each component of a mirror set;
attaching the RAIDs to a specific virtual disk for a mirror device; and
specifying a size for the virtual disk and mapping the size of the virtual disk directly to all components of the mirror set.

7. A program storage device readable by a computer tangibly embodying one or more programs of instructions executable by the computer to perform a method for dynamically shrinking mirrored virtual disks in a RAID storage system, the method comprising:
specifying a size of a virtual disk and mapping the size of the virtual disk directly to all components of a mirror set;
detaching any RAIDs that extend beyond the specified size of the virtual disk; and
truncating RAIDs to free up any excess physical segments back into the RAID storage system.

8. An apparatus for dynamically resizing mirrored virtual disks in a RAID storage system, comprising:
a storage system interface for providing access to a storage system;
host side interface for communicating with host devices; and
a processor, coupled to the host side interface and the storage system interface, the processor being configured for receiving a request to dynamically resize mirrored virtual disks in a RAID storage system, manipulating RAIDs in the RAID storage system to provide the desired resizing of the mirrored virtual disk and providing the resized mirrored virtual disks for operation.

9. The apparatus of claim 8 wherein the processor is further configured for creating an amount of storage necessary by providing RAIDs on each subsystem that is associated with each component of a mirror set, attaching the RAIDs to a specific virtual disk for a mirror device and specifying a size for the virtual disk and mapping the size of the virtual disk directly to all components of the mirror set.

10. The apparatus of claim 8 wherein the processor is further configured for specifying a size of a virtual disk and mapping the size of the virtual disk directly to all components of a mirror set, detaching any RAIDs that extend beyond the specified size of the virtual disk and truncating RAIDs to free up any excess physical segments back into the RAID storage system.

11. A storage area network, comprising:
a plurality of hosts;
at least one access device, coupled to the plurality of hosts, for managing data input/output operations; and
a storage platform, for providing networked storage to the at least one access device, the storage platform including a management device for dynamically resizing mirrored virtual disks in a RAID storage system, the management device further comprising:
a storage system interface for providing access to a storage system;
host side interface for communicating with host devices; and
a processor, coupled to the host side interface and the storage system interface, the processor being configured for receiving a request to dynamically resize mirrored virtual disks in a RAID storage system, manipulating RAIDs in the RAID storage system to provide the desired resizing of the mirrored virtual disk and providing the resized mirrored virtual disks for operation.

12. The storage area network of claim 11 wherein the processor is further configured for creating an amount of storage necessary by providing RAIDs on each subsystem that is associated with each component of a mirror set, attaching the RAIDs to a specific virtual disk for a mirror device and specifying a size for the virtual disk and mapping the size of the virtual disk directly to all components of the mirror set.

13. The storage area network of claim 11 wherein the processor is further configured for specifying a size of a virtual disk and mapping the size of the virtual disk directly to all components of a mirror set, detaching any RAIDs that extend beyond the specified size of the virtual disk and truncating RAIDs to free up any excess physical segments back into the RAID storage system.

14. An apparatus for dynamically resizing mirrored virtual disks in a RAID storage system, comprising:
first means for providing an interface to a storage system;
second means for providing communication with host devices; and
means, coupled to the host side interface and the storage system interface, for receiving a request to dynamically resize mirrored virtual disks in a RAID storage system, manipulating RAIDs in the RAID storage system to provide the desired resizing of the mirrored virtual disk and providing the resized mirrored virtual disks for operation.

15. The apparatus of claim 14 wherein the means for manipulating further comprises means for creating an amount of storage necessary by providing RAIDs on each subsystem that is associated with each component of a mirror set, attaching the RAIDs to a specific virtual disk for a mirror device and specifying a size for the virtual disk and mapping the size of the virtual disk directly to all components of the mirror set.

16. The apparatus of claim 14 wherein the means for manipulating further comprises means for specifying a size of a virtual disk and mapping the size of the virtual disk directly to all components of a mirror set, detaching any RAIDs that extend beyond the specified size of the virtual disk and truncating RAIDs to free up any excess physical segments back into the RAID storage system.
